(19) United States
(12) Patent Application Publication
(10) Pub. No.: US 2013/0004059 A1
(43) Pub. Date: Jan. 3, 2013

(54) ALIGNING STEREOSCOPIC IMAGES

(76) Inventor: Amir Said, Cupertino, CA (US)

(21) Appl. No.: 13/175,313

(22) Filed: Jul. 1, 2011

(51) Int. Cl. G06K 9/00

(52) U.S. Cl. 382/154

(57) ABSTRACT

Systems, methods, and computer-readable and executable instructions are provided for aligning stereoscopic images. Aligning stereoscopic images can include applying, by a computer, a feature detection technique to a pair of stereoscopic images to detect a number of features in each stereoscopic image. Aligning stereoscopic images can also include creating, by the computer, a feature coordinate list for each stereoscopic image based on the feature detection and comparing, by the computer, the feature coordinate lists. Furthermore, aligning stereoscopic images can include aligning the stereoscopic images, by the computer, based on the comparison.

### BACKGROUND

Observing stereoscopic image pairs that are not aligned correctly can be visually stressful and painful to a viewer because his or her eyes may be forced to move to unnatural positions in order to view the image. A commonly used technique in computer vision is to characterize an image by identifying some special types of distinctive features (e.g., edges, corners). An algorithm may be used to try to match features from a similar or same object in two stereoscopic photographs, and a set of coordinate pairs for each matched feature can be used to find rotations and vertical shifts in the photographs, as well as obtain correct alignment. However, it is computationally expensive (e.g., inefficient) to match feature pairs, and it may be unnecessary because stereoscopy may only require correct global vertical displacement and rotation.

### BRIEF DESCRIPTION OF THE DRAWINGS

FIG. 1 is a flow chart illustrating an example of a method for aligning stereoscopic images according to the present disclosure.

FIGS. 2A-2C illustrate diagrams of example stereoscopic image pairs for an application according to the present disclosure.

FIG. 3 illustrates a block diagram of an example of a computer-readable medium in communication with processing resources for aligning stereoscopic images according to the present disclosure.

### DETAILED DESCRIPTION

Examples of the present disclosure may include methods, systems, and computer-readable and executable instructions and/or logic. An example method for aligning stereoscopic images may include applying, by a computer, a feature detection technique to a pair of stereoscopic images to detect a number of features in each image. An example method for aligning stereoscopic images may also include creating, by the computer, a feature coordinate list for each stereoscopic image based on the feature detection and comparing, by the computer, the feature coordinate lists. Furthermore, the example method may include aligning the stereoscopic images, by the computer, based on the comparison.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

Stereoscopy, which can also be referred to as stereoscopic or three dimensional (3-D) imaging, is a technique for creating or enhancing the illusion of depth in an image by presenting two offset images separately to the left and right eye of the viewer. Stereoscopic image pairs can be created with a monoscopic camera by taking photos from two positions at approximately the same height and same orientation. Camera calibration techniques are also used to create stereoscopic images. However, following the creation of the stereoscopic images, the images have to be properly aligned to eliminate effects created by camera rotation, height variation, and/or other factors.

In computer vision, stereo matching can be used to describe a process of finding 3D information from two or more images. This can be used for image understanding, robotic navigation, and other processes. However, these processes are not normally used for creating stereoscopic images for humans to see.

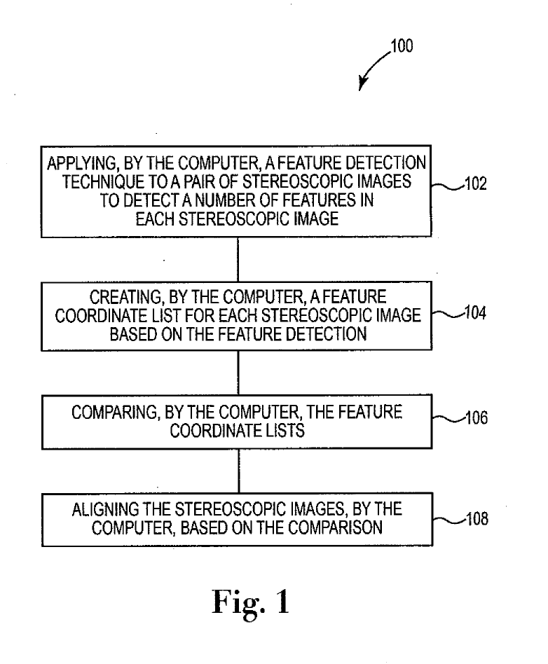

FIG. 1 is a flow chart 100 illustrating an example of a method for aligning stereoscopic images according to the present disclosure. The method can allow for a finding of a desired rotation and vertical shift for uncalibrated stereoscopic images (e.g., photograph pairs) without the need to perform a full epipolar determination of camera parameters or expensive pair-wise matching of image features. Epipolar geometry is the geometry of stereo vision. When two cameras view a 3D scene from two distinct positions, there can be a number of geometric relations between the 3D points and their projections onto two-dimensional (2D) images that lead to constraints between image feature points. The identification of desired rotation and vertical shift can result in parallax disparity being controlled and set to a desired value (e.g., a choice of virtual depth) by moving images horizontally.

Parallax is an effect whereby the position or direction of an object appears to differ when viewed from different positions. For example, parallax can affect optical instruments such as binoculars, microscopes, and twin-lens reflex cameras that view objects from slightly different angles. Many animals, including humans, have two eyes with overlapping visual fields that use parallax to gain depth perception; this process is known as stereopsis. In computer vision, the effect can be used for computer stereo vision.

At 102, a feature detection technique is applied to a pair of stereoscopic images to detect a number of features in each image. The feature detection technique can include a technique that defines image features as a point, such as, among others, scale-invariant feature transform (SIFT), rotation-invariant feature transform (RIFT), generalized robust invariant feature (G-RIF), speeded up robust features (SURF), principal component analysis SIFT (PCA-SIFT), gradient location and/or orientation histogram (GLOH), blob detection, and/or corner detection.

Features can be defined as points (e.g., feature points), and these points can be used in matching. For example, a corner of an object in an image can be a point with (x,y) coordinates. If the feature is defined as a region or a line, one point can be used as a representation. This point can correspond to a function that defines the feature. For example, the point can correspond to the maximum of the function.

Features (e.g., feature points) can include a piece or pieces of information relevant for solving a computational task related to a certain application. A requirement for a feature point can be that it can be differentiated from its neighboring image points. Image feature points can include, among others, corners, edges, blobs, and/or ridges. Corners, also known as interest points, refer to point-like features in an image, which have a local 2D structure. Corners can be detected as a place or angle where two or more sides or edges meet, and/or corners can be detected on parts of the image which were not corners in the traditional sense (e.g., a small bright spot on a dark background).

Edges can be points where there is a boundary (or an edge) between two image regions. An edge can be an arbitrary shape and can include junctions. Locally, edges can have a one dimensional structure. Blobs can provide a complementary description of image structures in terms of regions, as opposed to corners that are more point-like. Blob descriptors can contain a preferred point which means that many blob detectors may also be regarded as interest point operators. Blobs may be detected in areas in an image which are too smooth to be detected as a corner. For elongated objects, ridges can be detected. A ridge can be a one-dimensional curve that represents an axis of symmetry, and in addition has an attribute of local ridge width associated with each ridge point.

In an example of feature detection, if an image pair includes a photograph of a person, the person's eyes, nose, feet, and/or top of his or her head may be used as a feature point. Other objects or areas of interest can also be used as feature points. Each feature point can have an (x,y) coordinate, making the point detectable by feature detection techniques.

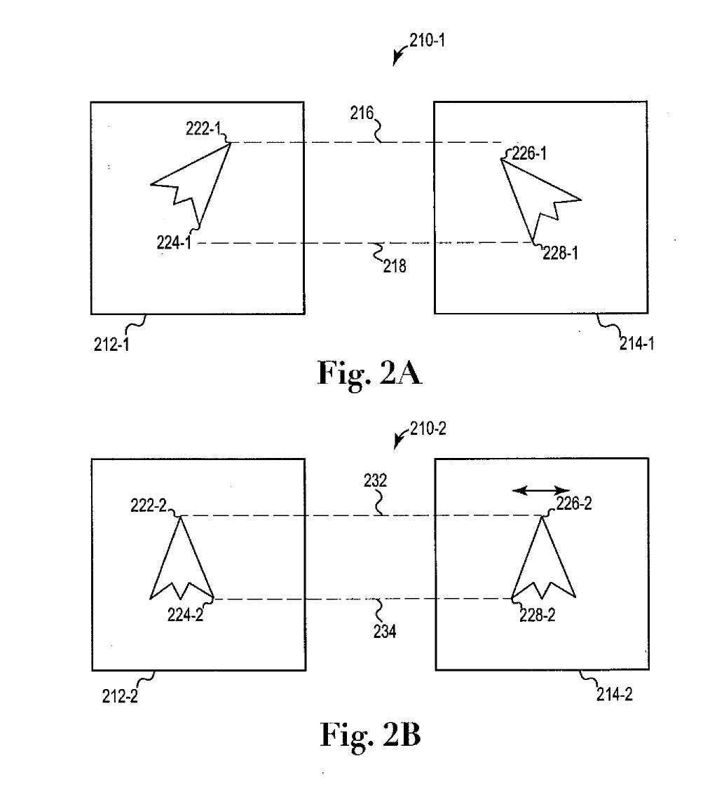

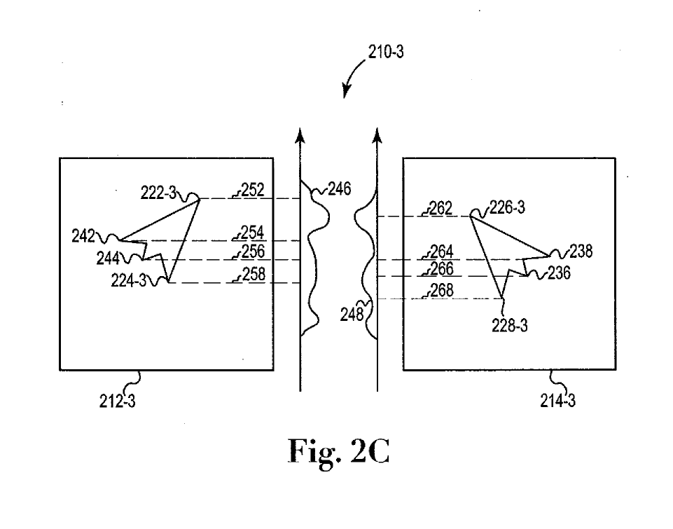

At 104, a feature coordinate list for each stereoscopic image is created based on the feature detection. For example, two lists of feature coordinates can be created. The feature coordinate lists can include vertical and horizontal coordinates (e.g., (x,y) coordinates) for each feature (e.g., feature point) in each image, and the feature coordinate lists can also include extra data such as, the orientation of features, among others. A number of features with similar vertical coordinates can be computed, and a histogram (e.g., a profile) for each image and its vertical coordinates can be created, as described further herein with respect to FIG. 2C. The histogram can represent how many features exist along or between a number of y-coordinates, with histograms including complex numbers containing more information than histograms without complex numbers.

A one-dimensional profile with accumulating sums of horizontal and/or vertical coordinates (e.g., (x,y,) coordinates) of each feature point in each image can be constructed. The accumulating sums can include complex-valued numbers. A feature rotation (e.g., rotation around a certain axis of the image) and a feature shift (e.g., horizontal and vertical movement) can also be determined for each feature point in each image. The feature rotation can be compared to a predetermined feature rotation threshold using a one-dimensional search, and the feature shift can be compared to a predetermined feature shift threshold using a Fast Fourier Transform (FFT).

At 106, the feature coordinate lists are compared. The comparison can result in the determination of a vertical displacement defining a match (e.g., a “best” match) that has a cross-correlation (e.g., similarity of waveforms) of the feature profiles that meets or exceeds a cross-correlation threshold. For example, a best match can be defined by the maximum cross-correlation of the feature profiles. A cross-correlation can exceed the predetermined cross-correlation when a feature rotation meets and/or exceeds a predetermined feature rotation threshold and a feature shift meets and/or exceeds a predetermined feature shift threshold.

In an example of cross-correlation, two real-valued functions f and g differ only by an unknown shift along the x-axis. Cross-correlation can be used to determine how much g must be shifted along the x-axis to make it identical to f. Cross-correlation can be computed using a number of FFTs, including, for example, a Cooley-Tukey FFT algorithm, a Prime-factor FFT algorithm, a Bruun's FFT algorithm, a Rader's FFT algorithm, and/or a Bluestein's FFT algorithm. An FFT is an algorithm to compute the discrete Fourier transform (DFT) and its inverse. A DFT decomposes a sequence of values into components of different frequencies, and an FFT is a way to compute the same result more quickly. Using an FFT in relation to image histograms can result in increased speed with respect to results as compared to convolution.

Different rotations can change feature coordinates, which in turn, can affect a feature histogram. A one-dimensional search for a rotation angle threshold (e.g., a maximum rotation angle) can be performed, and for each angle, the threshold (e.g., a maximum) can be given by the FFT. This search can be repeated for each angle. Feature orientation can be useful for matches if the number of features is small, and can be represented, if sums of features are replaced by a sum of complex values, with a phase (e.g., an argument) representing feature direction. A phase of a non-zero complex number can have a number of values. The FFT can be readily applied to complex-valued numbers for cross-correlation computation, and use of the FFT can result in complex-valued numbers.

At 108, the stereoscopic images are aligned based on the feature coordinate lists comparison. Comparisons of cross-correlation computations can be used when aligning the images, with cross-correlations meeting and/or exceeding a cross-correlation threshold being used to determine a desired alignment. The feature rotations comparison and the feature shift comparisons can also be used when aligning the images. The images can be aligned in order to reduce vertical disparities, and the aligned pair can be shifted horizontally, but need not be shifted vertically. In an example, one image of the pair is fixed, while another image is adjusted until aligned with the fixed image.

Replacing feature matching with FFT computations and a rotation angle search can reduce the complexity of image comparison and alignment. The complexity can be less dependent on the number of feature points, so techniques can be used that produce larger numbers of feature points. Furthermore, the features may not have to be as complicated as some that are needed to speed up a matching process. A reduction in complexity can be useful for implementation in embedded systems and handheld devices (e.g., mobile devices).

FIGS. 2A-2C illustrate diagrams of example stereoscopic image pairs for an application according to the present disclosure. FIG. 2A illustrates a diagram of an example stereoscopic image pair 210-1 including left-view image 212-1 and right-view image 214-1 that are not aligned. For example, right view image 214-1 and left view image 212-1 do not have a rotation and vertical shift needed for alignment. Left view image 212-1 includes feature points 224-1 and 222-1 that do not align with right view image 214-1 feature points 228-1 and 226-1, respectively. Dashed lines 216 and 218 represent horizontal lines (e.g., x-axes), and illustrate the misalignment of feature points 222-1 and 224-1 with feature points 226-1 and 228-1, respectively. Each feature point 222-1, 224-1, 226-1, and 228-1 can have an (x,y) coordinate.

FIG. 2B illustrates a diagram of an example stereoscopic image pair 210-2 including left-view image 212-2 and right-view image 214-2 that are aligned. Left view image 212-2 includes feature points 224-2 and 222-2 that are in alignment with right view image 214-2 feature points 228-2 and 226-2, respectively. Dashed lines 232 and 234 represent horizontal lines (e.g., x-axes), and illustrate the alignment of feature points 222-2 and 224-2 with feature points 226-2 and 228-2, respectively. Each feature point 222-2, 224-2, 226-2, and 228-2 can have an (x,y) coordinate.

FIG. 2C illustrates a diagram of an example stereoscopic image pair 210-3 including left-view image 212-3 and right-view image 214-3. Left-view image 214-3 includes feature points 222-3, 224-3, 242, and 244. Left-view images 212-1, 212-2, and 212-3 can include more or less feature points than illustrated in FIGS. 2A-2C. Right-view image 214-3 includes feature points 226-3, 228-3, 238, and 236. Right-view images 214-1, 214-2, and 214-3 can include more or less feature points than illustrated in FIGS. 2A-2C. Each feature point 222-3, 224-3, 242, 244, 226-3, 228-3, 238, and 236 can have an (x,y) coordinate, and the coordinates of feature points 222-3, 224-3, 242, and 244 and feature points 226-3, 228-3, 238, and 236 can be compared and used to create histograms (e.g., profiles) for each image 212-3 and 214-3. Histogram 246 represents a profile of feature point vertical coordinates in left-view image 212-3, and histogram 248 represents a profile of feature point vertical coordinates in right-view image 214-3. In an example, histograms 246 and 248 include only vertical feature point coordinate data for each image 212-3 and 214-3.

Histograms 246 and 248 are not mirror images of one another because images 212-3 and 214-3 are not aligned. As images become closer to alignment, the shapes of the curves can become more similar (e.g., closer to mirror images). Feature points represented in the histogram can have different x-coordinates, but the same y-coordinates. Dashed lines 252, 254, 256, 258, 262, 264, 266, and 268 represent horizontal lines (e.g., x-axes), and illustrate an association of each feature point with histograms 246 and 248. For example, the point on the histogram 246 that represents feature point 222-3 is shown by dashed line 252.

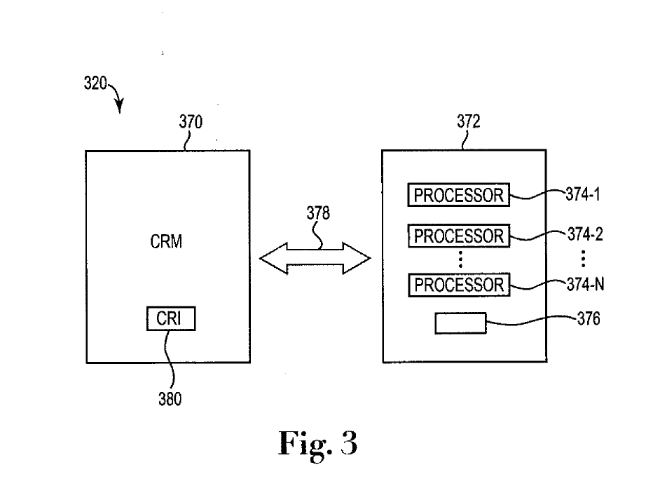

FIG. 3 illustrates a block diagram 320 of an example of a computer-readable medium in communication with processing resources for aligning stereoscopic images according to the present disclosure. Computer-readable medium (CRM) 370 can be in communication with a computing device 372, having processor resources of more or fewer than 374-1, 374-2, . . . , 374-N, that can be in communication with, and/or receive a tangible non-transitory CRM 370 storing a set of computer-readable instructions 380 executable by one or more of the processor resources (e.g., 374-1, 374-2, . . . , 374-N) for aligning images as described herein. The computing device may include memory resources 376, and the processor resources 374-1, 374-2, . . . , 374-N may be coupled to the memory resources 376.

Processor resources 374-1, 374-2, . . . , 374-N can execute computer-readable instructions 380 for aligning stereoscopic images that are stored on an internal or external non-transitory CRM 370. A non-transitory CRM (e.g., CRM 370), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), Blu-ray discs (BD), compact discs (CD), and/or a solid state drive (SSD), flash memory, etc., as well as other types of CRM.

The non-transitory CRM 370 can be integral, or communicatively coupled, to a computing device, in either in a wired or wireless manner. For example, the non-transitory CRM can be an internal memory, a portable memory, a portable disk, or a memory located internal to another computing resource (e.g., enabling computer-readable instructions 380 to be downloaded over the Internet).

The CRM 370 can be in communication with the processor resources (e.g., 374-1, 374-2, . . . , 374-N) via a communication path 378. The communication path 378 can be local or remote to a machine associated with the processor resources 374-1, 374-2, . . . , 374-N. Examples of a local communication path 378 can include an electronic bus internal to a machine such as a computer where the CRM 370 is one of volatile, non-volatile, fixed, and/or removable storage medium in communication with the processor resources (e.g., 374-1, 374-2, . . . , 374-N) via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 378 can be such that the CRM 370 is remote from the processor resources (e.g., 374-1, 374-2, . . . , 374-N) such as in the example of a network connection between the CRM 370 and the processor resources (e.g., 374-1, 374-2, . . . , 374-N). That is, the communication path 378 can be a network connection. Examples of such a network connection can include a local area network (LAN), a wide area network (WAN), a personal area network (PAN), and the Internet, among others. In such examples, the CRM 370 may be associated with a first computing device and the processor resources (e.g., 374-1, 374-2, . . . , 374-N) may be associated with a second computing device.

Processor resources 374-1, 374-2, . . . , 374-N coupled to the memory 376 can apply a feature detection technique to a pair of stereoscopic images to detect a number of features in each stereoscopic image. Processor resources 374-1, 374-2, . . . , 374-N coupled to the memory 376 can also construct a one-dimensional profile with accumulating sums of coordinates of each of the number of features and determine a number of feature rotations and feature shifts in each stereoscopic image.

The processor resources 374-1, 374-2, . . . , 374-N coupled to the memory 376 can also compare each of the number of feature rotations to a predetermined feature rotation threshold using a one-dimensional search and compare each of the number of feature shifts to a predetermined feature shift threshold using an FFT. Furthermore, processor resources 374-1, 374-2, . . . , 374-N coupled to the memory 376 can align the stereoscopic images based on the feature rotations comparisons and the feature shift comparisons.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed:

1. A computer-implemented method for aligning stereoscopic images comprising:
applying, by the computer, a feature detection technique to a pair of stereoscopic images to detect a number of features in each stereoscopic image;
creating, by the computer, a feature coordinate list for each stereoscopic image based on the feature detection;
comparing, by the computer, the feature coordinate lists; and
aligning the stereoscopic images, by the computer, based on the comparison.

2. The method of claim 1, wherein the method comprises fixing a first stereoscopic image of the pair and aligning a second stereoscopic image of the pair to the first stereoscopic image.

3. The method of claim 1, wherein the feature coordinate lists comprise feature orientations for each feature in each stereoscopic image and vertical and horizontal coordinates for each feature in each stereoscopic image.

4. The method of claim 1, further comprising generating a histogram of vertical coordinates for each of the number of stereoscopic images.

5. The method of claim 1, further comprising aligning the stereoscopic images through horizontal movement only.

6. The method of claim 1, wherein the method is performed on a mobile device.

7. A computer-readable non-transitory medium storing a set of instructions for aligning stereoscopic images executable by the computer to cause the computer to:
apply a feature detection technique to a pair of stereoscopic images to detect a number of features in each stereoscopic image;
create a feature coordinate list for each stereoscopic image based on the feature detection, wherein each of the feature coordinate lists includes vertical and horizontal feature coordinates;
compute a cross-correlation between each of the feature coordinates in the feature coordinate lists; and
align the stereoscopic images based on a comparison of the cross-correlation computations to a predetermined cross-correlation threshold.

8. The computer-readable non-transitory medium of claim 7, wherein a histogram is created for each of the stereoscopic images based on the vertical coordinates included in each of the feature coordinate lists.

9. The computer-readable non-transitory medium of claim 7, wherein the cross-correlation computations include only vertical coordinates cross-correlation computations.

10. The computer-readable non-transitory medium of claim 7, wherein the cross-correlations are computed using a Fast Fourier Transform.

11. A system for aligning stereoscopic images, comprising:
a memory; and
a processor coupled to the memory, to:
apply a feature detection technique to a pair of stereoscopic images to detect a number of features in each stereoscopic image;
construct a one-dimensional profile with accumulating sums of coordinates of each of the number of features;
determine a number of feature rotations and feature shifts in each stereoscopic image;
compare each of the number of feature rotations to a predetermined feature rotation threshold using a one-dimensional search;
compare each of the number of feature shifts to a predetermined feature shift threshold using a Fast Fourier Transform; and
align the stereoscopic images based on the feature rotations comparisons and the feature shift comparisons.

12. The system of claim 11, wherein a cross-correlation between each of the coordinates exceeds a predetermined cross-correlation threshold when one of the number of feature rotations meets or exceeds the predetermined feature rotation threshold and one of the number of feature shifts meets or exceeds the predetermined feature shift threshold.

13. The system of claim 11, wherein the accumulating sums comprise complex-valued numbers.

14. The system of claim 11, wherein the system is an embedded system.

15. The system of claim 11, wherein the feature detection technique comprises at least one of scale-invariant feature transform (SIFT), rotation-invariant feature transform (RIFT), generalized robust invariant feature (G-RIF), speeded up robust features (SURF), principal component analysis SIFT (PCA-SIFT), gradient location and orientation histogram (GLOH), blob detection, and corner detection.
